(19) United States
(12) Patent Application Publication
(10) Pub. No.: US 2009/0106938 A1
(43) Pub. Date: Apr. 30, 2009

(54) HINGE DEVICE FOR CONSOLE BOX

(75) Inventor: Yuichi Mori, Tokyo (JP)

Correspondence Address: DARBY & DARBY P.C., P.O. BOX 770, Church Street Station, New York, NY, 10008-0770, US

(73) Assignee: Hino Motors, Ltd., Tokyo (JP)

(21) Appl. No.: 12/051,483

(22) Filed: Mar. 19, 2008

(30) Foreign Application Priority Data
Oct. 31, 2007 (JP) 2007-283006

(51) Int. Cl. E05F 1/14

(52) U.S. Cl. 16/277

(57) ABSTRACT

A hinge device for a console box includes a body arm 21 fixed to a console body; a shaft on the body arm; a lid arm attached to a console lid and pivotally supported on the shaft; and elastic members windingly provided on the shaft and one end of which is fixed to the body arm and the other end is fixed to the lid arm. The lid arm is pivotally supported on the shaft so as to be turned around from which the console lid closes the console body so that the console body is openable. The elastic members consist of a first torsion coil spring that urges the lid arm in a closed state in the opening direction and a second torsion coil spring that urges the turned-around lid arm in the closing direction. Thereby, the console lid that closes the console body is urged in the opening direction and also the turned-around console lid is urged in the closing direction without remarkably decreasing the service life of the hinge device.

### CROSS-REFERENCE TO RELATED APPLICATION

The present application claims priority under 35 U.S.C. §119 to Japanese Patent Application No. 2007-283006 filed on Oct. 31, 2007. The contents of the application is incorporated herein by reference in its entirety.

### BACKGROUND OF THE INVENTION

1. Field of the Invention

The present invention relates to a hinge device having an elastic member for urging a console lid that closes a console body by rotating it into place. More particularly, it relates to a hinge device for a console box, which is used to open a console body by turning a console lid around.

2. Description of the Related Art

Conventionally, between the driver seat and the passenger seat of a vehicular front seat, a console box is provided. The console box is configured so that a console body is fixed to a floor, and a console lid is attached to the upper side of the console body via a hinge device so as to be openable and closable. For ease of opening/closing of the console lid, the hinge device is provided with an elastic member for urging the console lid that closes the console body so as to turn the console lid (for example, refer to Japanese Unexamined Patent Application Publication No. 1996(H08)-91130 (Claims for the Patent, FIG. 1)). That is to say, the hinge device of conventional console box includes a body arm attached to the console lid, a shaft provided on the body arm, and a lid arm that is pivotally supported on the shaft and turnably supports the console lid around the shaft. The elastic member is a so-called torsion coil spring windingly provided on the shaft, and one end thereof is fixed to the body arm and the other end thereof is fixed to the lid arm.

The torsion coil spring is made by winding a hard steel wire, a piano wire, or a stainless steel wire for spring so as to be in contact spirally. As shown FIG. 12, the torsion coil spring 2 provides a neutral point in an unloaded state, and a winding angle α is determined by an angle formed by an arm part 3 of one end of a wound wire and an arm part 4 of the other end thereof. For this torsion coil spring 2, if the arm parts 3 and 4 are twisted in the winding direction, which is the direction in which the winding is intensified, as indicated by the dashed line by applying a load to the arm parts 3 and 4 of one end and the other end, the arm parts 3 and 4 tend to return to the neutral point of original winding angle α due to the restoring force of the torsion coil spring 2. Therefore, this torsion coil spring 2 is windingly provided on the shaft as an elastic member, so that in the state in which the console body is closed, the torsion coil spring 2 is twisted in the winding direction from the winding angle α, by which the console lid that closes the console body is urged in the opening direction by the restoring force of the torsion coil spring 2. If the torsion coil spring 2 having a winding angle α of about 90 degrees is used, in the state in which the console lid is turned in the opening direction and is erected, the arm parts 3 and 4 of the torsion coil spring 2 return to the neutral point of the winding angle α, by which the console lid that has opened the console body is prevented from being urged further.

On the other hand, a technique has been proposed in which the console lid is turned about 180 degrees from the state in which the console body is closed and turned around, by which the back side of the console lid is utilized in an upwardly directed state. In the technique in which the console lid is turned around, if the torsion coil spring 2 having a winding angle α of about 90 degrees as shown in FIG. 12 is used as an elastic member, in the state in which the console lid is turned around, the arm parts 3 and 4 of the torsion coil spring 2 are twisted in the direction reverse to the winding direction, that is, in the developing direction in which the winding is loosened, as indicated by the two-dot chain line, exceeding the neutral point of the winding angle α. As shown in FIG. 13, even when the torsion coil spring 2 is twisted in the developing direction in which the winding is loosened exceeding the neutral point of the winding angle α, the arm parts 3 and 4 tend to restore due to the restoring force of the torsion coil spring 2. Therefore, if the torsion coil spring 2 having a winding angle α of about 90 degrees is used as an elastic member for urging the lid arm, the console lid is urged in the opening direction, and also in the state in which the console lid is turned around, the console lid is urged in the closing direction. That is to say, since the elastic member consisting of the torsion coil spring 2 urges the console lid into an erected state, this configuration is thought to be favorable because the lid arm is urged in the erecting direction when the console lid is released or closed.

However, as a general property of the torsion coil spring 2, if the torsion coil spring 2 is twisted in the direction reverse to the winding direction, that is, in the developing direction exceeding the neutral point of the winding angle α, it has been known that a torque loss occurs, and the durability of the torsion coil spring 2 decreases. Therefore, for the console box in which the console lid is turned around, if the torsion coil spring 2 having a winding angle α of about 90 degrees is used as an elastic member, the torsion coil spring 2 is twisted about 90 degrees in the developing direction from the neutral point, which presents a problem in that there is created a loss of torque such that the torsion coil spring 2 tends to turn the console lid in a turned-around state in the closing direction, and the service life of the torsion coil spring itself, which is an elastic member, is reduced.

To solve this problem, for the hinge device used for the console box such that the console lid is turned around, it is thought that the torsion coil spring 2 having a winding angle α of about 180 degrees is used as an elastic member. If this torsion coil spring 2 is used, the torsion coil spring 2 is not twisted in the developing direction exceeding the neutral point at all angles ranging from the state in which the console lid closes the console body to the state in which the console lid is turned around, so that it is thought that the decrease in service life of the torsion coil spring 2 can be avoided.

However, the turning around of the console lid means that after the console lid has been turned 90 degrees and erected, it is turned 90 degrees further. Therefore, if the torsion coil spring 2 having a winding angle α of about 180 degrees is used as an elastic member, even when the erected console lid is further turned 90 degrees in the opening direction, the console lid is urged in the opening direction. Therefore, during the time from when the console lid is erected to when it is turned around, the energy of turning is increased by the urging force of the torsion coil spring 2 and the weight of the console lid.

Also, the torsion coil spring 2 having a winding angle α of about 180 degrees provides the neutral point of the winding angle α at which no urging force is generated in the state in which the console lid has turned 180 degrees, so that the turned-around console lid provides a resistance at the time when it is returned to the erected state. That is to say, if the torsion coil spring 2 having a winding angle α of about 180 degrees is used as an elastic member, the action of closing the console body again by turning the turned-around console lid in the closing direction is hindered, and also the initial urging force for urging the closed console lid in the opening direction becomes excessive.

### SUMMARY OF THE INVENTION

Accordingly, the object of the present invention is to provide a hinge device for a console box, which can urge a console lid that closes a console body in the opening direction and also can urge the turned-around console lid in the closing direction without remarkably decreasing the service life thereof.

A first aspect of the present invention is an improvement in a hinge device for a console box including a body arm fixed to a console body having a storage part; a shaft provided on the body arm; a lid arm that is attached to a console lid provided above the console body so as to be openable and closable and is pivotally supported on the shaft; and elastic members and which are windingly provided on the shaft and one end of which is fixed to the body arm and the other end of which is fixed to the lid arm as shown in FIG. 1 and FIG. 11.

The characteristic configuration thereof is that the lid arm is pivotally supported on the shaft so as to be turned around from the state in which the console lid closes the console body so that the console body is openable; the elastic members are formed by first and second torsion coil springs and passing through a winding angle during the time when the lid arm is opened or closed; the first torsion coil spring is configured so as to be twisted in the winding direction from a neutral point in the state in which the lid arm is closed and to be twisted in the developing direction from the neutral point in the state in which the lid arm is opened; and the second torsion coil spring is configured so as to be twisted in the developing direction from the neutral point in the state in which the lid arm is closed and to be twisted in the winding direction from the neutral point in the state in which the lid arm is opened.

For the hinge device for a console box of the first aspect, since the elastic members consist of the first torsion coil spring and the second torsion coil spring, the urging force of the lid arm is the sum of the urging forces of the first and second torsion coil springs. Since the first torsion coil spring is a spring that urges the lid arm in a closed state in the opening direction, when the lid arm turns in the opening direction, the urging force thereof weakens gradually toward the neutral point consisting of the winding angle. Also, since the second torsion coil spring is a spring that urges the turned-around lid arm in the closing direction, when the turned-around lid arm turns in the closing direction, the urging force thereof weakens gradually toward the neutral point consisting of the winding angle. Since the first and second torsion coil springs and pass through the neutral point during the time when the lid arm is opened or closed, the sum of the urging forces of the first and second torsion coil springs and that urge the lid arm urges the console lid that closes the console body in the opening direction and also urges the turned-around console lid in the closing direction.

A second aspect of the present invention is characterized in that in the first aspect of the present invention, the hinge device is configured so that during the time when the lid arm is opened or closed, when either one of the first and second torsion coil springs and provides the neutral point, the other of the first and second torsion coil springs does not provide the neutral point.

If both of the first and second torsion coil springs provide the neutral point at the same time during the time when the lid arm is opened or closed, both urging forces, from the first and second torsion coil springs that tend to turn the lid arm become zero at the same time, which makes the lid arm, shaky. However, for the hinge device for a console box of the second aspect of the present invention, an urging force is always given to the lid arm, so that a situation such that the lid arm becomes shaky can be avoided.

A third aspect of the present invention is characterized in that in the first or second aspect of the present invention, the first torsion coil spring provides the neutral point when the lid arm is opened 100 to 120 degrees from a closed state, and the second torsion coil spring provides the neutral point when the lid arm is opened 60 to 80 degrees from a closed state.

If the torsion coil springs are twisted in the developing direction, which is the direction reverse to the winding direction, exceeding the neutral point, a torque loss occurs and also the durability of the torsion coil springs decreases. However, the degree thereof is proportional to the angle through which the torsion coil springs are twisted in the developing direction. For the hinge device for a console box of the third aspect of the present invention, in the state in which the lid arm is turned around, the first torsion coil spring is twisted 80 to 60 degrees in the developing direction exceeding the neutral point consisting of the winding angle α. Therefore, in the state in which the console lid closes the console body, the second torsion coil spring is twisted 80 to 60 degrees in the developing direction exceeding the neutral point consisting of the winding angle α, and the twisting angle in the developing direction can be kept at an angle smaller than 90 degrees. Thereupon, the hinge device for a console box of the third aspect of the present invention can urge the console lid that closes the console body in the opening direction and also can urge the turned-around console lid in the closing direction without remarkably decreasing the service life thereof.

For the hinge device for a console box in accordance with the present invention, since the elastic members are formed by the first torsion coil spring and the second torsion coil spring, the urging force of the lid arm can be made the sum of the urging forces of the first and second torsion coil springs. Since the first torsion coil spring is a spring that urges the lid arm in a closed state in the opening direction, and the second torsion coil spring is a spring that urges the turned-around lid arm in the closing direction, the sum of the urging forces of the first and second torsion coil springs that urge the lid arm can urge the console lid that closes the console body in the opening direction and also can urge the turned-around console lid in the closing direction. If the first and second torsion coil springs are set so as to provide the neutral point respectively at different opening angles of the lid arm, the console lid that closes the console body can be urged in the opening direction and also the turned-around console lid can be urged in the closing direction without remarkably decreasing the service life of the torsion coil springs.

### BRIEF DESCRIPTION OF THE DRAWINGS

FIG. 1 is a sectional view taken along the line A-A of FIG. 2, showing a hinge device in accordance with an embodiment of the present invention;

FIG. 2 is a perspective view of a hinge device in a state in which a console lid closes a console body;

FIG. 3 is a perspective view of a hinge device in a state in which a lid arm is erected;

FIG. 4 is a perspective view of a hinge device in a state in which a lid arm is turned around;

FIG. 5 is an exploded perspective view showing a configuration of a hinge device;

FIG. 6 is a sectional view taken along the line B-B of FIG. 5, showing a first torsion coil spring;

FIG. 7 is a graph showing the characteristics of the first torsion coil spring shown in FIG. 6;

FIG. 8 is a sectional view taken along the line C-C of FIG. 5, showing a second torsion coil spring;

FIG. 9 is a graph showing the characteristics of the second torsion coil spring shown in FIG. 8;

FIG. 10 is a graph showing the characteristics of the sum of the first and second torsion coil springs;

FIG. 11 is a side view of a console box;

FIG. 12 is a side view of a torsion coil spring provided in a conventional hinge device; and

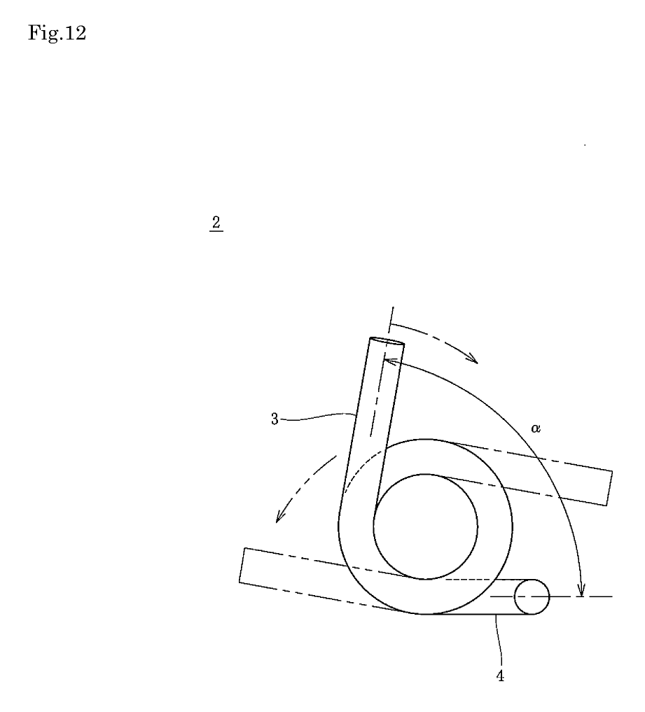

FIG. 13 is a graph showing the characteristics of a conventional torsion coil spring.

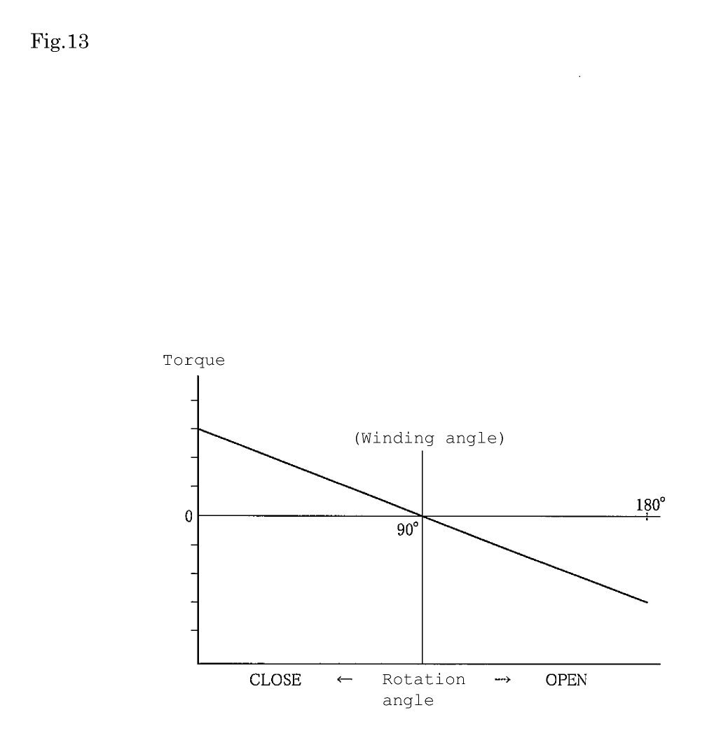

### DETAILED DESCRIPTION OF THE INVENTION

Embodiments of the present invention will now be described with reference to the attached drawings.

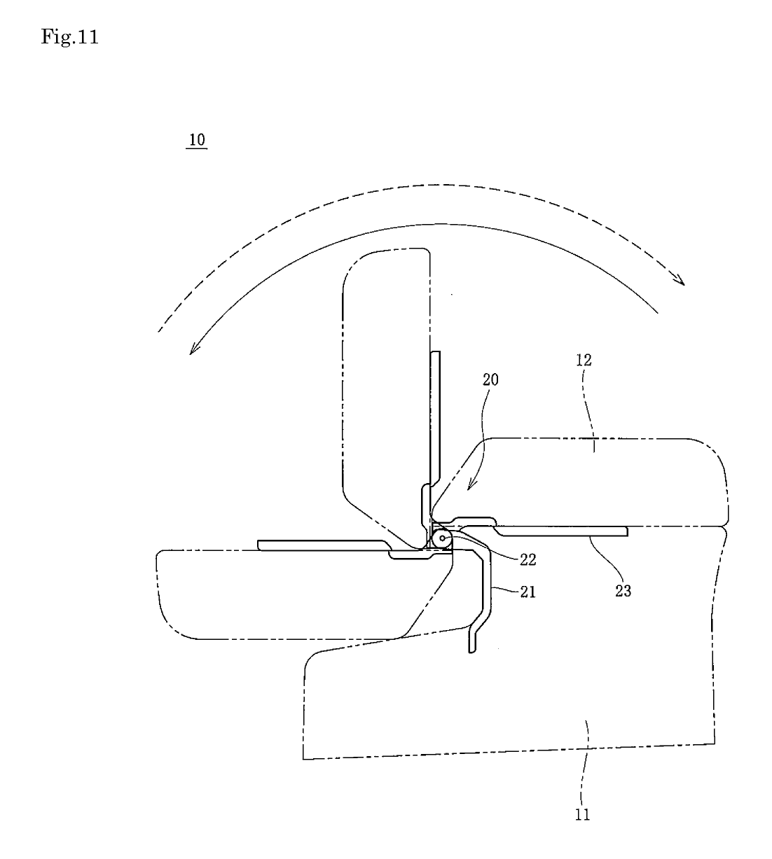

As shown in FIG. 11, a console box 10 provided between the driver seat and the passenger seat of a vehicular front seat includes a console body 11 having a storage part fixed on a floor, not shown, a console lid 12 provided above the console body 11 to close the console body 11 openably, and a hinge device 20 for connecting the console lid 12 to the console body 11. The hinge device 20 for the console box 10 includes a body arm 21 fixed to the console body 11, a shaft 22 provided on the body arm 21, and a lid arm 23 that is attached to the console lid 12 and is pivotally supported on the shaft 22. This console box 10 is configured so that the console lid 12 is turned around about 180 degrees as indicated by the solid line from the state in which the console body 11 is closed, by which the back side of the console lid 12 can be utilized in an upwardly directed state. Therefore, the lid arm 23 is pivotally supported on the shaft 22 so as to be turned around from the state in which the console body 11 is closed to open the console body 11.

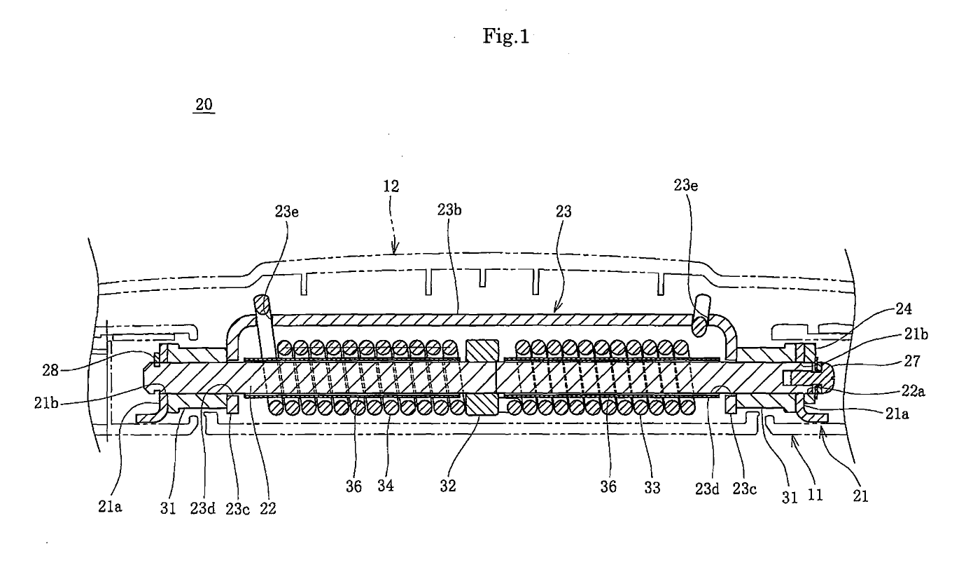

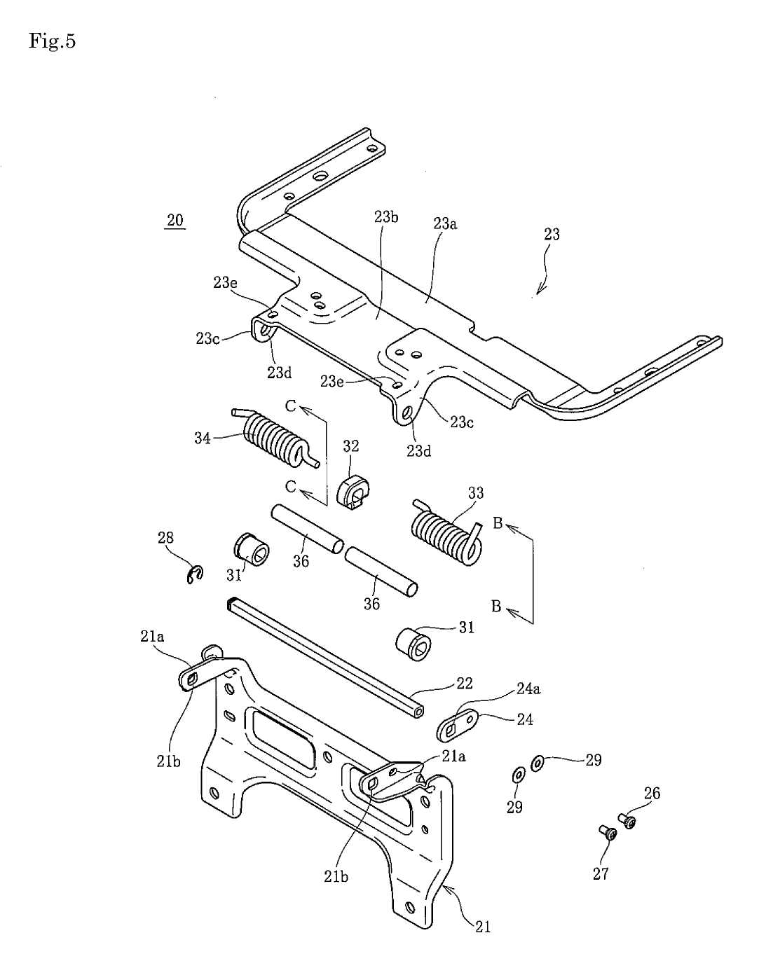

As shown in FIGS. 1 to 5, the body arm 21 of the hinge device 20 is attached in an erected state to the front part of the console body 11. At both sides in the vehicle width direction in the upper part of the body arm 21, a pair of attaching flanges 21a are integrally formed so as to face to each other, and to the outside of one of the attaching flanges 21a, a reinforcing plate 24 is attached with a set screw 26. As shown in FIGS. 1 to 5, in the paired attaching flanges 21a and the reinforcing plate 24, attachment holes 21b and 24a each having, for example, a square cross section are formed penetratingly in a coaxial manner, respectively. The shaft 22 is formed so that the outside diameter thereof has a cross section almost the same as that of the attachment holes 21b and 24a. The shaft 22 is set between the paired attaching flanges 21a so as to be unable to rotate in a state of being inserted through the attachment holes 21b and 24a. One end of the shaft 22 is attached to the outside of one of the attaching flanges 21a via the reinforcing plate 24 with a mounting screw 27, and the other end of the shaft 22 is mounted with an E-ring 28 on the outside of the other of the attaching flanges 21a. Thus, the shaft 22 is provided so as to be unable to rotate with respect to the body arm 21. Reference numeral 29 in FIG. 5 denotes a washer provided for the set screw 26 and the mounting screw 27.

As shown in FIGS. 1, 2 and 5, the lid arm 23 has a U-shaped body part 23a attached substantially horizontally to the front part of the console lid 12 for closing the console body 11 so that the opening thereof is located at the rear, and an attachment part 23b formed in the front part of the body part 23a. Both sides in the vehicle width direction of the attachment part 23b are bent downward, by which, on both sides of the attachment part 23b, a pair of attached flanges 23c facing to each other are formed integrally with the attachment part 23b. The distance between the paired attached flanges 23c is shorter than the distance between the paired attaching flanges 21a of the body arm 21. In each of the paired attached flanges 23c, an insertion hole 23d having a circular cross section is penetratingly formed so that the shaft 22 can be inserted therethrough. By setting the shaft 22 having been inserted through the insertion holes 23d between the paired attaching flanges 21a, the lid arm 23 is pivotally supported on the shaft 22 so as to be rotatable. Reference numeral 31 in the figures denotes a positioning bush for attaching the lid arm 23 to the center of the shaft 22. Reference numeral 32 in the figures denotes a locking member which is attached in the center of the shaft 22 so as to be unable to rotate with respect to the shaft 22, and to which one end of each of elastic members 33 and 34, described later, is attached.

Also, for ease of opening/closing of the console lid 12, the hinge device 20 is provided with the elastic members 33 and 34 for urging the console lid 12 that closes the console body 11 to turn it. The elastic members 33 and 34 are windingly provided on the shaft 22. One end of each of the elastic members 33 and 34 is fixed to the body arm 21, and the other end thereof is fixed to the lid arm 23. The elastic members 33 and 34 consist of first and second torsion coil springs 33 and 34 passing through a neutral point during the time when the lid arm 23 is opened or closed. The first and second torsion coil springs 33 and 34 in this embodiment are fitted on the outside of cylindrical sleeves 36 fitted on the shaft 22, and are wound around the shaft 22 via the sleeves 36. One end of each of the first and second torsion coil springs 33 and 34 wound around the shaft 22 is locked to the locking member 32 attached to the center of the shaft 22 so as to be unable to rotate with respect to the shaft 22. That is, one end of each of the first and second torsion coil springs 33 and 34 is fixed to the body arm 21 via the locking member 32 and the shaft 22. On the other hand, the other end of each of the first and second torsion coil springs 33 and 34 is inserted in a locking hole 23e formed in the attachment part 23b of the lid arm 23, by which the other end of each of the first and second torsion coil springs 33 and 34 is directly fixed to the lid arm 23.

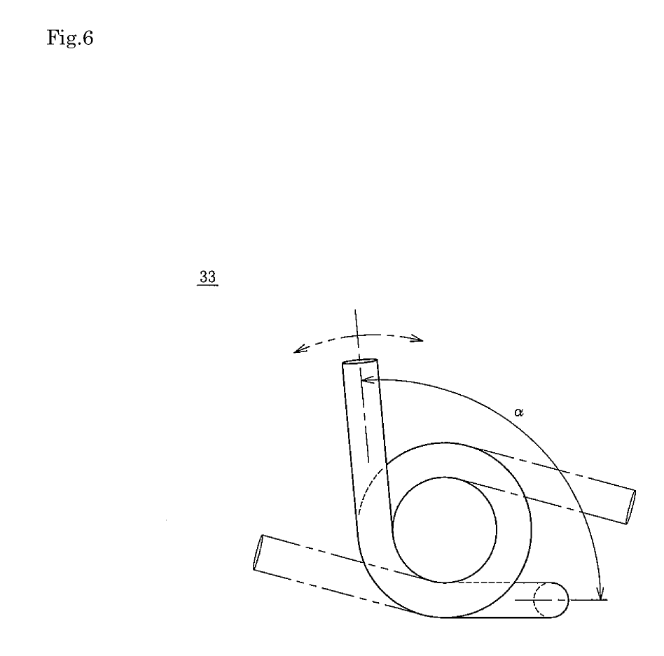

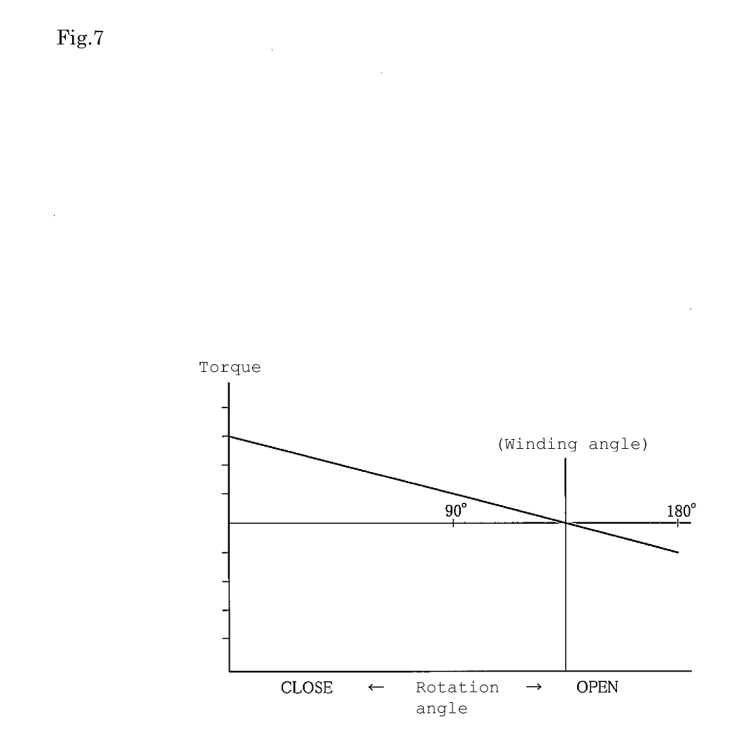

As shown in FIG. 6, the first torsion coil spring 33 is a torsion coil spring that is twisted in the winding direction from the neutral point consisting of a winding angle α in the state in which the lid arm 23 is closed, and urges the lid arm 23 in the opening direction so as to open the console lid 12 that closes the console body 11. The first torsion coil spring 33 is also a torsion coil spring that is twisted in the developing direction from the neutral point in the state in which the lid arm 23 is opened, and urges the lid arm 23 in the direction in which the opened console lid 12 is closed. The first torsion coil spring 33 in this embodiment is a torsion coil spring having a winding angle α of 100 to 120 degrees. The property of the torsion coil spring constituting the first torsion coil spring 33 is that as shown in FIG. 7, in the state in which the console lid 12 is turned 90 degrees to be erected, and then is turned further 10 to 30 degrees toward the side opposite to the console body 11, the neutral point consisting of the winding angle α is provided, and the closed console lid 12 is urged in the opening direction to the neutral point. On the other hand, in the state in which the console lid 12 is turned around, the torsion coil spring is twisted in the developing direction exceeding the neutral point as indicated by the two-dot chain line in FIG. 6, and the turned-around console lid 12 is urged in the closing direction of the console body 11 to the neutral point.

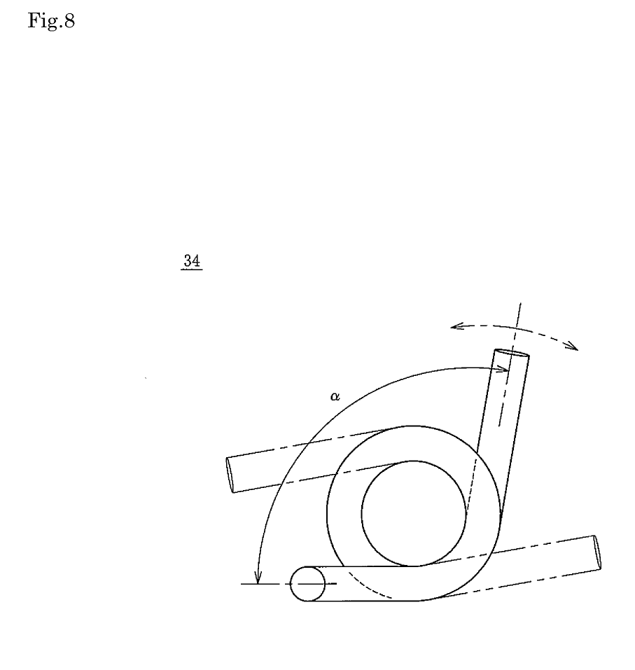

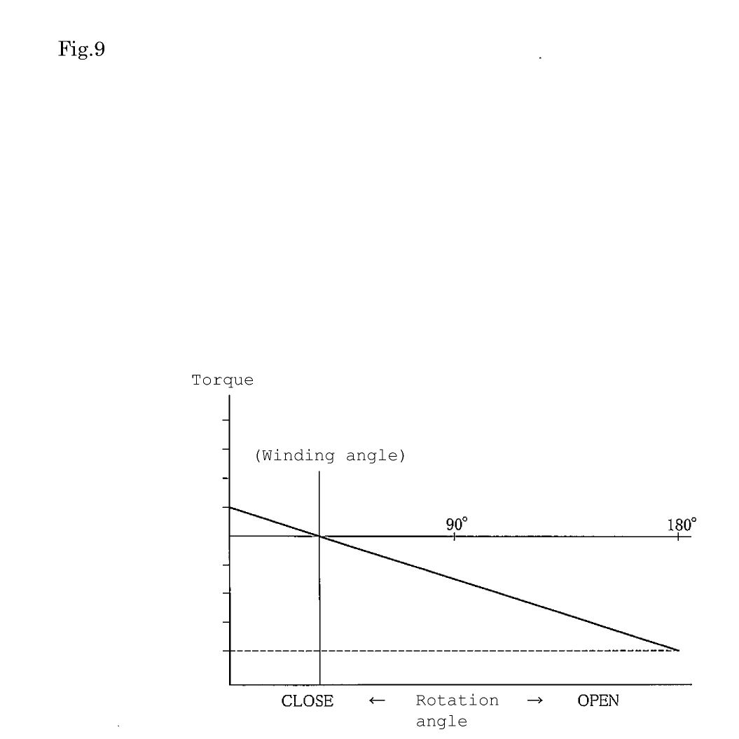

On the other hand, as shown in FIG. 8, the second torsion coil spring 34 is a torsion coil spring that is twisted in the winding direction from the neutral point consisting of the winding angle α in the state in which the lid arm 23 is opened, and urges the turned-around lid arm 23 in the closing direction. The second torsion coil spring 34 is also a torsion coil spring that is twisted in the developing direction from the neutral point in the state in which the lid arm 23 is closed, and urges the lid arm 23 in a closed state in the opening direction. The second torsion coil spring 34 in this embodiment is a torsion coil spring having a winding angle α of 100 to 120 degrees. The property of the torsion coil spring constituting the second torsion coil spring 34 is that as shown in FIG. 9, in the state in which the turned-around console lid 12 is turned 90 degrees to be returned and erected, and then is turned further 10 to 30 degrees in the closing direction, the neutral point consisting of the winding angle α is provided, and the console lid 12 is urged in the closing direction to the neutral point. On the other hand, in the state in which the console lid 12 closes the console body 11, the torsion coil spring is twisted in the developing direction exceeding the neutral point as indicated by the two-dot chain line in FIG. 8, and the console lid 12 that closes the console body 11 is urged in the opening direction of the console body 11 to the neutral point consisting of the winding angle α.

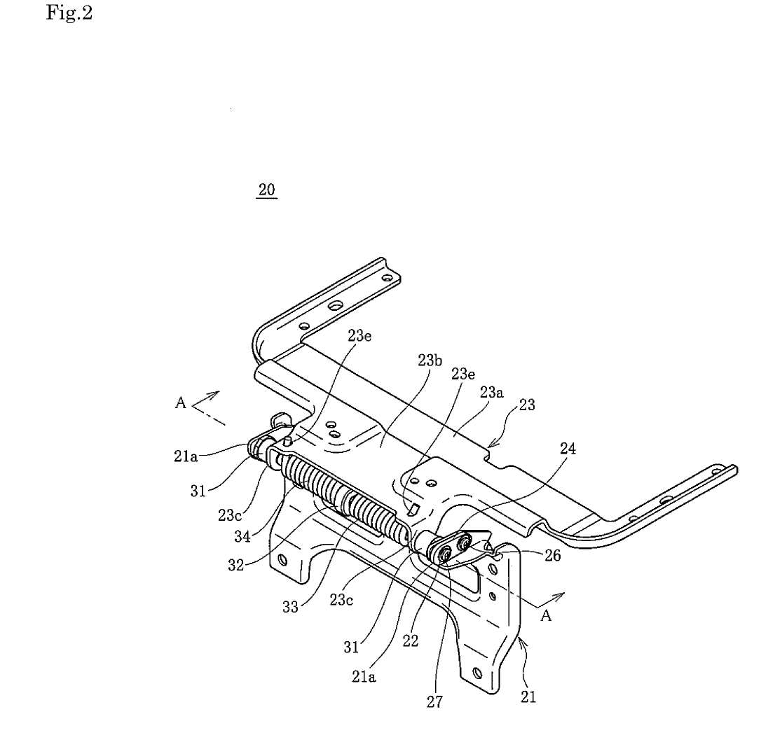

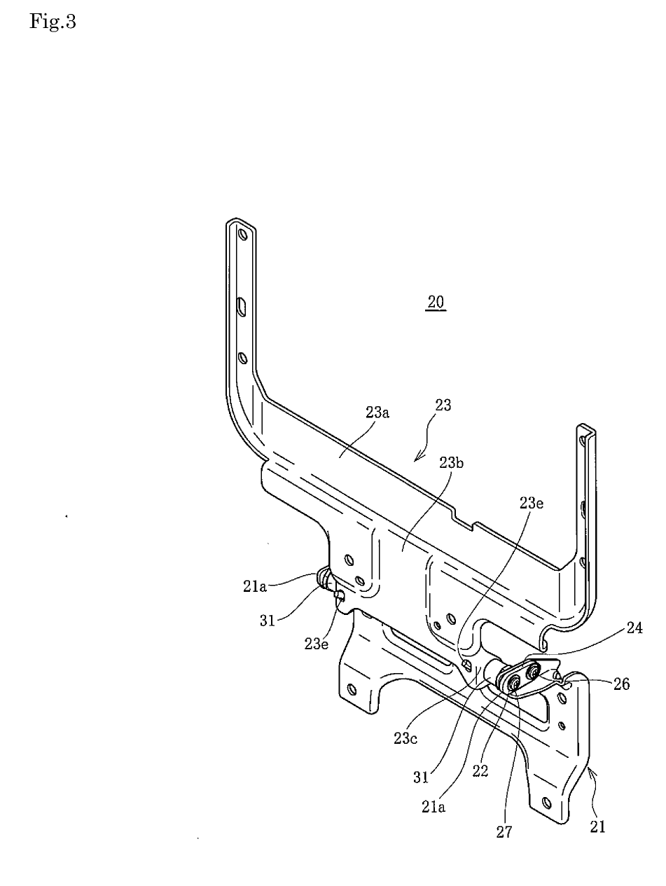

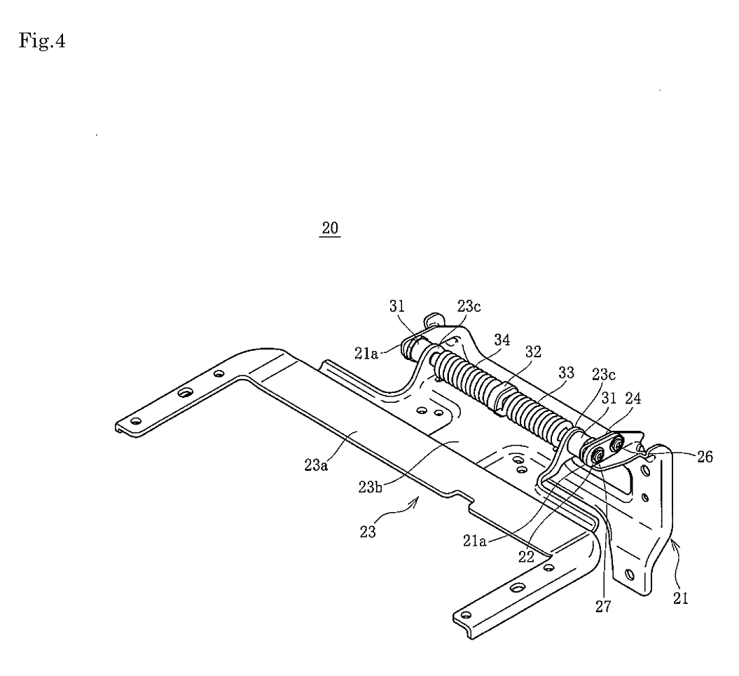

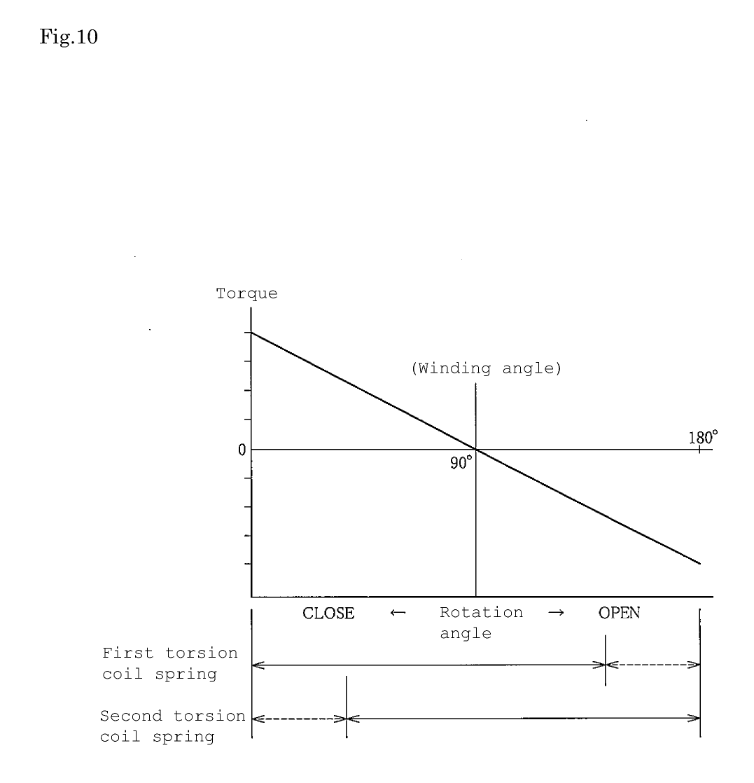

For the hinge device for the console box configured as described above, since the elastic member consists of the first torsion coil spring 33 and the second torsion coil spring 34, the urging force of the lid arm 23 is the sum of the urging forces of the first and second torsion coil springs 33 and 34. Since the first torsion coil spring 33 urges the lid arm 23 in a closed state as shown in FIG. 2 in the opening direction, as shown in FIG. 7, when the lid arm 23 turns in the opening direction, the urging force thereof weakens gradually toward the neutral point consisting of the winding angle α. Also, since the second torsion coil spring 34 urges the turned-around lid arm 23 as shown in FIG. 4 in the closing direction, as shown in FIG. 9, when the turned-around lid arm 23 turns in the closing direction, the urging force thereof weakens gradually toward the neutral point consisting of the winding angle α. Since the first and second torsion coil springs 33 and 34 pass through the neutral point during the time when the lid arm 23 is opened or closed, the sum of the urging forces of the first and second torsion coil springs 33 and 34 urging the lid arm 23 urges the console lid 12 that closes the console body 11 in the opening direction, and also urges the turned-around console lid 12 in the closing direction as shown in FIG. 10. As shown in FIG. 3, the lid arm 23 is always urged so as to be in an erected state.

If the torsion coil springs 33 and 34 are twisted in the developing direction, which is the direction reverse to the winding direction, exceeding the neutral point, a torque loss occurs and also the durability of the torsion coil springs decreases. However, the degree thereof is proportional to the angle through which the torsion coil springs 33 and 34 are twisted from the neutral point. Although the winding angle of the first torsion coil spring 33 is 100 to 120 degrees, and the first torsion coil spring 33 is twisted about 80 to 60 degrees in the developing direction exceeding the neutral point in the state in which the lid arm 23 is turned around, the twisting angle in the developing direction can be kept to an angle smaller than 90 degrees. Also, although the winding angle of the second torsion coil spring 34 is 100 to 120 degrees, and the second torsion coil spring 34 is twisted about 80 to 60 degrees in the developing direction exceeding the neutral point in the state in which the console lid 12 closes the console body 11, the twisting angle in the developing direction can be kept to an angle smaller than 90 degrees. Therefore, the hinge device for a console box in accordance with the present invention can urge the console lid that closes the console body in the opening direction and also can urge the turned-around console lid in the closing direction without remarkably decreasing the service life thereof.

In the above-described embodiment, the case where one end of each of the first and second torsion coil springs 33 and 34 wound around the shaft 22 is fixed to the shaft 22, and the shaft 22 is attached to the body arm 21 so as to be unable to rotate has been explained. However, the configuration may be such that the shaft 22 is provided rotatably on the body arm 21, the lid arm 23 is provided on the shaft 22 so as to be unable to turn, one end of each of the first and second torsion coil springs 33 and 34 is fixed to the body arm 21, and the other end thereof is fixed to the shaft 22.

What is claimed is:

1. A hinge device for a console box comprising:
a body arm fixed to a console body having a storage part;
a shaft provided on the body arm;
a lid arm attached to a console lid provided above the console body so as to be openable and closable and is pivotally supported on the shaft; and
an elastic member windingly provided on the shaft and one end of which is fixed to the body arm and the other end of which is fixed to the lid arm, wherein
the lid arm is pivotally supported on the shaft so as to be turned around from a state in which the console lid closes the console body so that the console body is openable;
the elastic member is formed by first and second torsion coil springs passing through a neutral point during the time when the lid arm is opened or closed;
the first torsion coil spring is configured so as to be twisted in the winding direction from the neutral point in a state in which the lid arm is closed and to be twisted in the developing direction from the neutral point in a state in which the lid arm is opened; and
the second torsion coil spring is configured so as to be twisted in the developing direction from the neutral point in a state in which the lid arm is closed and to be twisted in the winding direction from the neutral point in a state in which the lid arm is opened.

2. The hinge device of claim 1, wherein the hinge device is configured so that during the time when the lid arm is opened or closed, when either one of the first and second torsion coil springs provides the neutral point, the other of the first and second torsion coil springs does not provide the neutral point.

3. The hinge device of claim 1, wherein the first torsion coil spring provides the neutral point when the lid arm is opened 100 to 120 degrees from a closed state, and the second torsion coil spring provides the neutral point when the lid arm is opened 60 to 80 degrees from a closed state.
